(19) United States
(12) Patent Application Publication
(10) Pub. No.: US 2015/0092697 A1
(43) Pub. Date: Apr. 2, 2015

(54) METHODS FOR DETERMINING INFORMATION ABOUT A COMMUNICATION PARAMETER AND COMMUNICATION DEVICES

(71) Applicant: Agency for Science, Technology and Research, Singapore (SG)

(72) Inventors: Wai Leong Yeow, Singapore (SG); Zhongding Lei, Singapore (SG); Shoukang Zheng, Singapore (SG); Haiguang Wang, Singapore (SG)

(73) Assignee: Agency for Science, Technology and Research, Singapore (SG)

(21) Appl. No.: 14/400,130

(22) PCT Filed: May 13, 2013
(86) PCT No.: PCT/SG2013/000188

§ 371 Date: Nov. 10, 2014

(30) Foreign Application Priority Data
May 11, 2012 (SG) 201203475-7
Nov. 9, 2012 (SG) 201208312-7

(51) Int. Cl. H04W 24/10; H04L 5/00

(52) U.S. Cl. CPC H04W 24/10; H04L 5/0055
USPC 370/329

(57) ABSTRACT

According to various embodiments, a method for determining information about a communication parameter may be provided. The method may include providing information about the communication parameter in at least one of an add block acknowledgement request signal, an acknowledgement signal for an add block acknowledgement request signal, an add block acknowledgement response signal, or an acknowledgement signal for an add block acknowledgement response signal.

### CROSS-REFERENCE TO RELATED APPLICATIONS

The present application claims the benefit of the Singapore patent application No. 201203475-7 filed on 11 May 2012 and of the Singapore patent application No. 201208312-7 filed on 9 Nov. 2012, the entire contents of both are incorporated herein by reference for all purposes.

### TECHNICAL FIELD

Embodiments relate generally to methods for determining information about a communication parameter and to communication devices.

### BACKGROUND

In wireless radio communication, asymmetric communications may occur, where one communication party (for example an access point) may have higher transmission power than another communication party (for example a mobile station). It may be desired to exchange information about the specific communication abilities of the devices.

### SUMMARY

According to various embodiments, a method for determining information about a communication parameter may be provided. The method may include providing information about the communication parameter in at least one of an add block acknowledgement request signal, an acknowledgement signal for an add block acknowledgement request signal, an add block acknowledgement response signal, or an acknowledgement signal for an add block acknowledgement response signal.

According to various embodiments, a communication device may be provided. The communication device may include a communication circuit configured to at least one of send or receive information about the communication parameter in at least one of an add block acknowledgement request signal, an acknowledgement signal for an add block acknowledgement request signal, an add block acknowledgement response signal, or an acknowledgement signal for an add block acknowledgement response signal.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a communication system in accordance with an embodiment;

FIG. 2A shows a flow diagram illustrating a method for determining information about a communication parameter according to various embodiments;

FIG. 2B shows a communication device according to various embodiments;

FIG. 3 shows a message sequence chart for Block ACK mechanism according to IEEE where originator is the AP and recipient is STA;

FIG. 4 shows a static difference example according to various embodiments;

FIG. 5 shows an illustration of dynamic MCS for BA frame according to various embodiments;

FIG. 6 shows a change in BA frames for Basic and Compressed BA according to various embodiments;

FIG. 7 shows a BA frame format according to various embodiments;

FIG. 8 shows per TID INFO in Multi-TID BA according to various embodiments;

FIG. 9 shows a general MAC Header for IEEE 802.11;

FIG. 10 illustrates MAC header compression for two-way communication without management frame exchange for compression and without decompression context synchronization request according to various embodiments;

FIG. 11 illustrates MAC header compression for two-way communication without management frame exchange for compression where destination sends decompression context synchronization request according to various embodiments;

FIG. 12 illustrates MAC header compression for two-way communication with management frame exchange for compression and without decompression context synchronization request according to various embodiments;

FIG. 13 illustrates MAC header compression for two-way communication with management frame exchange for compression where destination sends decompression context synchronization request according to various embodiments;

FIG. 14 illustrates MAC header compression for unidirectional transmission without management frame exchange for compression and without decompression context synchronization request according to various embodiments;

FIG. 15 illustrates MAC header compression for unidirectional transmission without management frame exchange for compression where destination sends decompression context synchronization request according to various embodiments;

FIG. 16 illustrates MAC header compression for unidirectional transmission with management frame exchange for compression and without decompression context synchronization request according to various embodiments;

FIG. 17 illustrates MAC header compression for unidirectional transmission with management frame exchange for compression where destination sends decompression context synchronization request according to various embodiments;

FIG. 18 shows an expanded CCMP MPDU according to various embodiments; and

FIG. 19 shows the fields of Compressed CCMP header.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the communication device as described in this description may include a memory which is for example used in the processing carried out in the communication device. In this context, the access point as described in this description may include a memory which is for example used in the processing carried out in the access point. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

A communication device may for example be an access point or a station, for example a mobile station.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

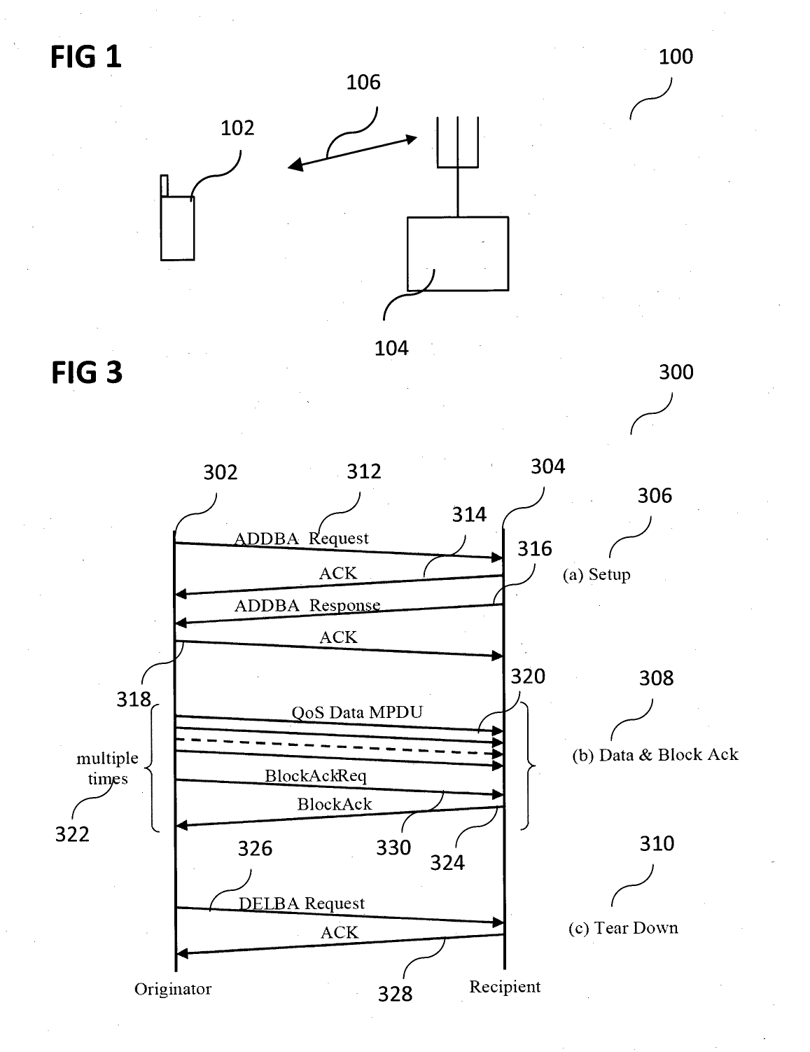

FIG. 1 shows a communication system 100, for example a wireless local area network, according to various embodiments. A wireless access point 102 (which may also be referred to as AP) may communicate with a communication device 104, for example a mobile radio communication station (which may also be referred to as station or as STA), like indicated by arrow 106.

In wireless radio communication, asymmetric communications may occur, where one communication party (for example an access point) may have higher transmission power than another communication party (for example a mobile station). It may be desired to exchange information about the specific communication abilities of the devices.

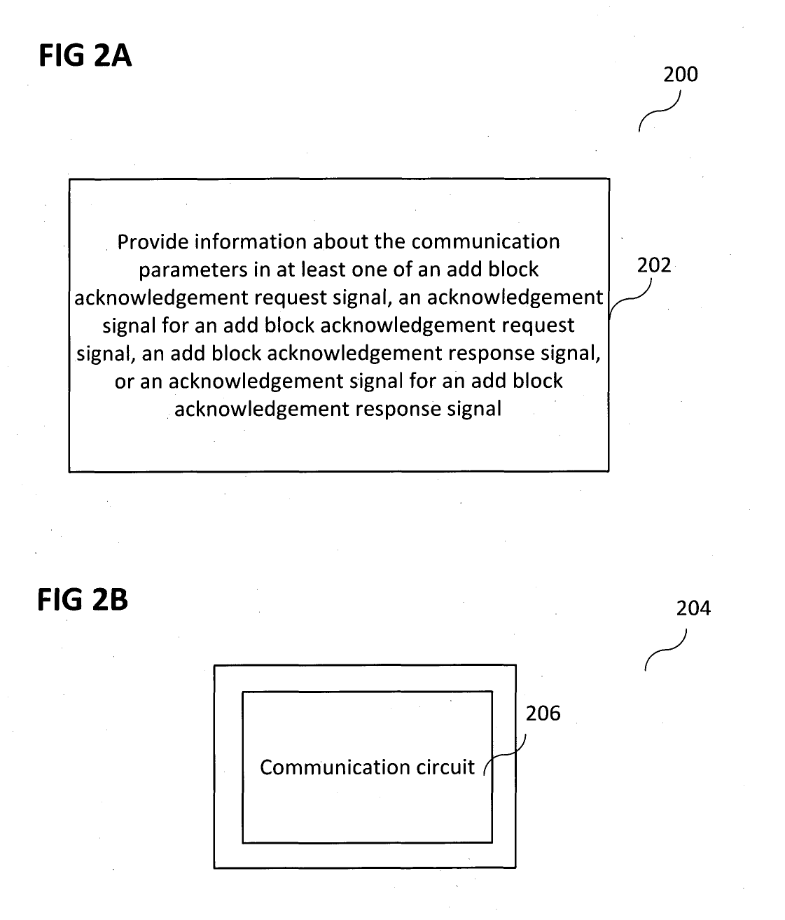

FIG. 2A shows a flow diagram 200 illustrating a method for determining information about a communication parameter according to various embodiments. In 202, information about the communication parameter may be provided in at least one of an add block acknowledgement request signal, an acknowledgement signal for an add block acknowledgement request signal, an add block acknowledgement response signal, or an acknowledgement signal for an add block acknowledgement response signal.

According to various embodiments, the communication parameter may include or may be at least one of the following parameters: a modulation and coding scheme; a data rate; an uplink modulation and coding scheme; an uplink data rate; a downlink modulation and coding scheme; a downlink data rate; an index of a modulation and coding scheme (MCS); an index of an uplink modulation and coding scheme (uplink MCS); an index of a downlink modulation and coding scheme (downlink MCS); an index of a data rate; an index of an uplink data rate; an index of a downlink data rate; a difference between an uplink data rate and a downlink data rate; a difference in indices between a downlink modulation and coding scheme (downlink MCS) and an uplink modulation and coding scheme (uplink MCS); and a difference in indices between a downlink data rate and an uplink data rate.

According to various embodiments, the method may further include providing the information about the communication parameter in an indicator in the add block acknowledgement response frame.

According to various embodiments, the method may further include providing the information about the communication parameter in a status code in the add block acknowledgement response frame.

According to various embodiments, the method may further include providing the information about the communication parameter using a dialog token field.

According to various embodiments, the information about the communication parameter may include or may be an absolute value of at least one communication parameter and/or a change of at least one communication parameter compared to a presently used communication parameter.

According to various embodiments, the method may further include determining a duration for virtual carrier sensing mechanism based on the information about the communication parameter.

According to various embodiments, the method may further include reserving channel time for a block acknowledgement frame based on the determined duration.

According to various embodiments, the method may further include sending or receiving a block acknowledgement signal with dynamic block acknowledgement bitmap size.

According to various embodiments, the method may further include sending or receiving a signal indicating that sending of a block acknowledgement signal is finished.

FIG. 2B shows a communication device 204 according to various embodiments. The communication device 204 may include a communication circuit 206 configured to send and/or receive information about the communication parameter in at least one of an add block acknowledgement request signal, an acknowledgement signal for an add block acknowledgement request signal, an add block acknowledgement response signal, or an acknowledgement signal for an add block acknowledgement response signal.

According to various embodiments, the communication parameter may include or may be at least one of the following parameters: a modulation and coding scheme; a data rate; an uplink modulation and coding scheme; an uplink data rate; a downlink modulation and coding scheme; a downlink data rate; an index of a modulation and coding scheme (MCS); an index of an uplink modulation and coding scheme (uplink MCS); an index of a downlink modulation and coding scheme (downlink MCS); an index of a data rate; an index of an uplink data rate; an index of a downlink data rate; a difference between an uplink data rate and a downlink data rate; a difference in indices between a downlink modulation and coding scheme (downlink MCS) and an uplink modulation and coding scheme (uplink MCS); and a difference in indices between a downlink data rate and an uplink data rate.

According to various embodiments, the communication circuit 206 may further be configured to at least one of send or receive the information about the communication parameter in an indicator in the add block acknowledgement response frame.

According to various embodiments, the communication circuit 206 may further be configured to at least one of send or receive the information about the communication parameter in a status code in the add block acknowledgement response frame.

According to various embodiments, the communication circuit may further be configured to at least one of send or receive the information about the communication parameter using a dialog token field.

According to various embodiments, the information about the communication parameter may include or may be an absolute value of at least one communication parameter and/or a change of at least one communication parameter compared to a presently used communication parameter.

According to various embodiments, the communication circuit 206 may further be configured to determine a duration for virtual carrier sensing mechanism based on the information about the communication parameter.

According to various embodiments, the communication circuit may further be configured to reserve channel time for a block acknowledgement frame based on the determined duration.

According to various embodiments, the communication circuit may further be configured to send or receive a block acknowledgement signal with dynamic block acknowledgement bitmap size.

According to various embodiments, the communication circuit may further be configured to send or receive a signal indicating that sending of a block acknowledgement signal is finished.

According to various embodiments, devices and methods may be provided for asymmetric link operation.

According to various embodiments, methods for improving block ack (acknowledgement) operation in IEEE 802.11 networks may be provided.

The Block Acknowledgement (BA) function is a feature in the IEEE 802.11 standard used to enhance throughput by reducing signaling overhead. Without BA, a station (STA) returns an acknowledgement for every data frame received. With BA enabled, the station may return one single BA frame for multiple data frames received.

In the immediate BA mode in IEEE 802.11, the acknowledging STA is required to transmit the BA frame with the same data rate as that of the eliciting data frames. This may usually not be a problem with symmetrical links, wherein the data originating STA and the acknowledging STA may be of (or may have) the same radio capability, may use the same transmit power and may have similar channel conditions both ways.

However, the assumption may not be true in general and the asymmetric problem may be exemplified in the upcoming 802.11ah standard, which task group is established for supporting radio band below 1 GHz with the coverage by a single Access Point (AP) extended form a few hundred meters to 1 km, and supports low-power devices in some use-cases.

According to various embodiments, devices and methods may provide a protocol to allow the acknowledging STA to transmit a more robust (for example lower data rate and/or lower bandwidth) BA frame than the data originating STA, improving performance for asymmetric links.

In the following, the most common scenario is described. The data originating STA is referred as the AP and the acknowledging STA is referred as an associated non-AP STA, since an AP generally has higher radio capability and transmit power than a STA. The same procedures can, however, be applied to any two communicating STAs.

According to various embodiments, Block Acknowledgement (BA) in IEEE 802.11 may be provided to include information for communicating efficiently over asymmetric links.

According to various embodiments, asymmetric links in the MAC (media access control) layer may be supported.

Communication over asymmetric links in the physical layer may use different MCS (modulation and coding scheme), repetition methods and bandwidth. This information may be negotiated between the two communicating stations in the MAC layer. A negotiation function in IEEE 802.11 may be exploited to further include information for communicating efficiently over asymmetric links. This function is called Block Acknowledgement (BA).

Block Acknowledgement (BA) is a function in the 802.11 specification which aggregates several acknowledgements into one frame, thereby improving channel efficiency (see part (b) in FIG. 3).

FIG. 3 shows a message sequence chart 300 for Block ACK mechanism according to IEEE where originator 302 is the AP and recipient 304 is STA. A setup phase a) 306, a data and block ACK phase b) 308, and a tear down phase c) 310 are shown. The originator 302 may send an ADDBA (add block acknowledgement) 312 to the recipient 304. The recipient 304 may send an ACK 314 to the originator 302. The recipient 304 may send an ADDBA response 316 to the originator 302. The originator 302 may send an ACK 318 to the recipient. The originator 302 may send multiple QoS (quality of service) data MPDU (MAC (media access control) protocol data unit) 320 to the recipient 304. The originator 302 may send a BlockAckReq (BA request) 330 to the recipient 304. The recipient 304 may send a BlockAck (BA) 324 to the originator 302. Like indicated by 322, the data and block Ack phase 308 may be provided multiple times. The originator 302 may send a DELBA (delete BA) request 326 to the recipient. The recipient 304 may send an ACK 328 to the originator 302.

In the following, determination of the uplink and downlink data rates (for example MCS) at BA setup phase will be described.

The BA setup phase may include exchange of management messages ADDBA (add block acknowledgement) Request and ADDBA Response between the AP and the STA. Both the AP and the STA may use the management messages to measure and determine the downlink and uplink data rates. The recommendation from STA may be fed back via a possibly modified ADDBA Response message. This will be described in more detail below.

Since the AP has higher transmission power, it may transmit at higher MCS to the STA for the ADDBA Request message. However, the STA's ACK (acknowledgement) frame might not reach the AP. This may be because the MCS for ACK frame may be mandated to be the same as the ADDBA Request frame. With STA's lower transmission power, the ACK frame may not be received at the AP.

The AP may resend the ADDBA Request message and may adjust the downlink MCS until it obtains an ACK from the STA. In that case, the AP may determine what the appropriate MCS in the uplink is. In STA's ADDBA Response, it may indicate the highest MCS in which an ADDBA Request frame is received. This indication can be done in three ways:

A) Direct modification of the ADDBA Response frame to explicitly add an indicator for the recommended downlink MCS value.

B) Explicitly stating the downlink MCS value in the ADDBA Response frame as one of the status codes. There may be at least 65,000 reserved codes and some may be used to state the MCS value.

C) Implicitly stating the MCS value with no change to existing message format. This may desire the AP to change the “Dialog Token” field but keep the “Block ACK Seq Control” field unchanged for every new MCS tried in the ADDBA Request frame. In the ADDBA Response frame, the STA may indicate the best downlink MCS value by responding with the matching “Dialog Token” field.

In the following, determination of the uplink and downlink data rates (MCS) at BA Setup phase with Short-ACK will be described. Short-ACK is a new frame in IEEE 802.11ah which serves the ACK function. It is one of the special class of frames termed as NDP (null data packet) frame, which contains only PHY headers and no PHY data. It is always transmitted using the lowest MCS rate and thus is the most robust.

In the case where Short-ACK is used, the AP may determine immediately which downlink MCS is appropriate since Short-ACK may use the most reliable MCS in the same bandwidth as the AP. The STA may also know which MCS the AP uses for the downlink.

In the ADDBA response, the STA may select its own uplink MCS by trying various MCS on the ADDBA response frame until an ACK from the AP is received. The AP may also know which MCS the STA uses in the uplink.

It is to be noted that the ADDBA Request frame as described further above may also be used as a confirmation of the “negotiated” downlink and uplink MCS rates.

In the following, determination of the uplink and downlink bandwidth at BA setup phase will be described.

For more severe asymmetric links, it may be possible that the lowest MCS used in the uplink for ACK (or Short-ACK) may not reach the AP in the ADDBA Request handshake. In that case, the STA may have to use a lower bandwidth (and thereby obtaining higher average power) in order to reach the AP.

In this case, the AP may use the same method of trial-and-error as stated in the earlier section with varying data rates (MCS), and may further extend the ADDBA Request resends to lower bandwidths so that the STA can ACK in the lower bandwidths. The STA then indicates the appropriate downlink MCS and bandwidth in the ADDBA response using one of the three possible options described above.

In the following, timing delays due to bandwidth changes will be described.

In using lower bandwidth, additional time may be required to switch from higher bandwidth to lower bandwidth, and vice versa. The additional delay may not be factored into the design of the SIFS (Short Interframe Space), which may include the time between a frame transmitted and its corresponding ACK or Block ACK (in immediate mode) from the destination node. When necessary, the AP may specify a delay Block ACK policy when setting up the Block ACK in the ADDBA Request frame. The delay Block ACK policy then may factor in the time required for the change of bandwidth.

If the Block ACK Request (for example as indicated in (b) in FIG. 3) uses the lower bandwidth, then there may be no issue in timing delays and delayed Block ACK policy may not be desired. However, the limitation may be that the Block ACK may not be part of the QoS (quality of service) Data MPDU (MAC protocol data unit) burst as the latter may be in the higher bandwidth.

In the following, changing the uplink and downlink MCS and bandwidth between bursts will be described.

The AP may further signal to the STA to lower or increase the MCS and bandwidth dynamically for uplink by indicating those changes in the Block ACK Request, and the STA may do so for the downlink in the Block ACK Response. In both cases, the Block ACK Request and Response messages may be modified either by (i) adding additional fields, or (ii) using the reserved bits.

This may give flexibility to the AP and the STA but care must be made to ensure the recommended MCS and bandwidth are safe to be used.

Although the method for negotiation for asymmetric links is described in the context of Block ACK according to various embodiments, as it is expected to be the most frequent negotiation in IEEE 802.11 networks. However, it will be understood that the concept may similarly be applied to other negotiation functions will, like for example Association and Reassociation.

In the following, Robust BA with lower data rate will be described.

The difficulty with having a BA frame at a lower data rate (or bandwidth) is that the AP does not have any prior information on how to set the duration field (for the virtual carrier sensing mechanism in IEEE 802.11) in order to reserve the channel time for that returning BA frame. It is possible to for the AP to predict what data rate the STN will use for the BA frame, but this is not guaranteed.

According to various embodiments, the BA negotiation phase may be used to confirm the specific data rate and bandwidth both communicating STAs would be using. If channel conditions are symmetrical, then both sides only need to note the difference in data rate and bandwidth.

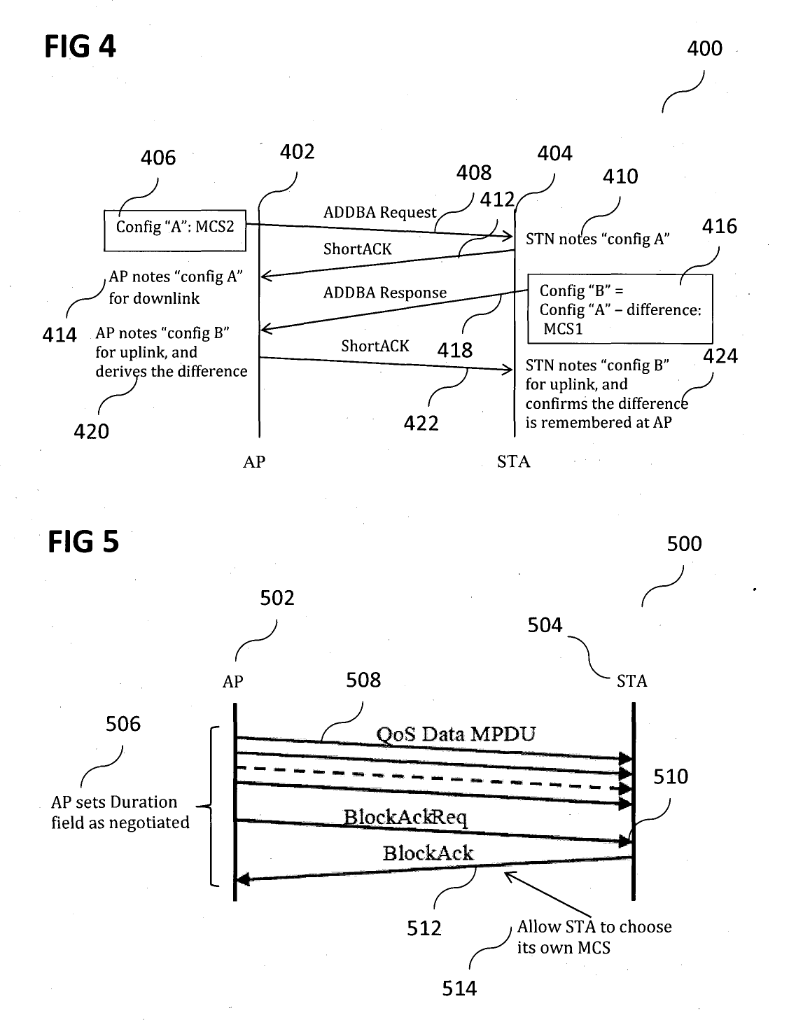

FIG. 4 shows a flow diagram 400 illustrating communication between an AP 402 and a STA 404. The AP 402 may send an ADDBA request 408 to the STA 404. The STA 404 may send a ShortACK 412 to the AP 402.

For example as shown in FIG. 4, the AP 402 may use data rate index MCS2 (which may be referred to as configuration A, as indicated by block 406) and STN (station, which may also be referred to as STA) 404 uses data rate index MCS1 (which may be referred to as configuration B). The STN may note the configuration A in 410. The difference may be 1 notch like indicated by block 416. The AP 402 may note the configuration A for downlink, like indicated in block 414. In the BA negotiation phase (ADDBA), the difference in the data rate indices for uplink and downlink may be set by the STA 404 when it returns the ADDBA 418 response to the AP 402. The AP 402 may note configuration B for uplink, and may derive the difference (like indicated by block 420), and may send a ShortACK 422 to the STA 404. The STA 404 then may confirm that the AP 402 has derived the difference once the ADDBA response frame is acknowledged, like indicated in block 424. Subsequent data frame and BA frame exchanges between the two parties may then be based on this negotiated difference in data rate index. In this example, if the AP uses MCS6, then it may expect the STA to use MCS5 and compute the duration needed for the BA frame based on MCS5.

The above example may assume that the STA knows the difference between the AP and the STA. This difference may be discovered via earlier frame exchanges since association and authentication, trial-and-error during the BA negotiation phase, or based on computation from existing techniques such as open-loop link adaptation.

Indication of the difference may be implicit as shown in the above example. It may also be any one of the three options described further above.

In the case where degree of asymmetry between the uplink and downlink are not constant, two other methods to complementary the one described above may be used.

In the following, dynamic Reduction of BA bitmap size will be described.

According to various embodiments, devices and methods may be provided which allows the STA to choose its own MCS for the BA frame while allowing the AP to set the duration field as baseline in IEEE 802.11-2012, or as per negotiated in the ADDBA phase (like will be described below with reference to FIG. 5 in more detail).

FIG. 5 shows an illustration of dynamic MCS for BA frame according to various embodiments. A flow diagram. 500 illustrating communication between an AP 502 and a STA 504 is shown. The AP 502 may send a plurality of QoS DATA MPDU 508 to the STA 504. The AP may then send a BlockAckReq 510 to the STA 510, and the STA 510 may send a BlockAck 512 to the AP 502. The STA 504 may be allowed to choose its own MCS for the BlockAck 512. The AP 502 may set a duration field as negotiated for the data flow shown in FIG. 5, like illustrated by bracket 506.

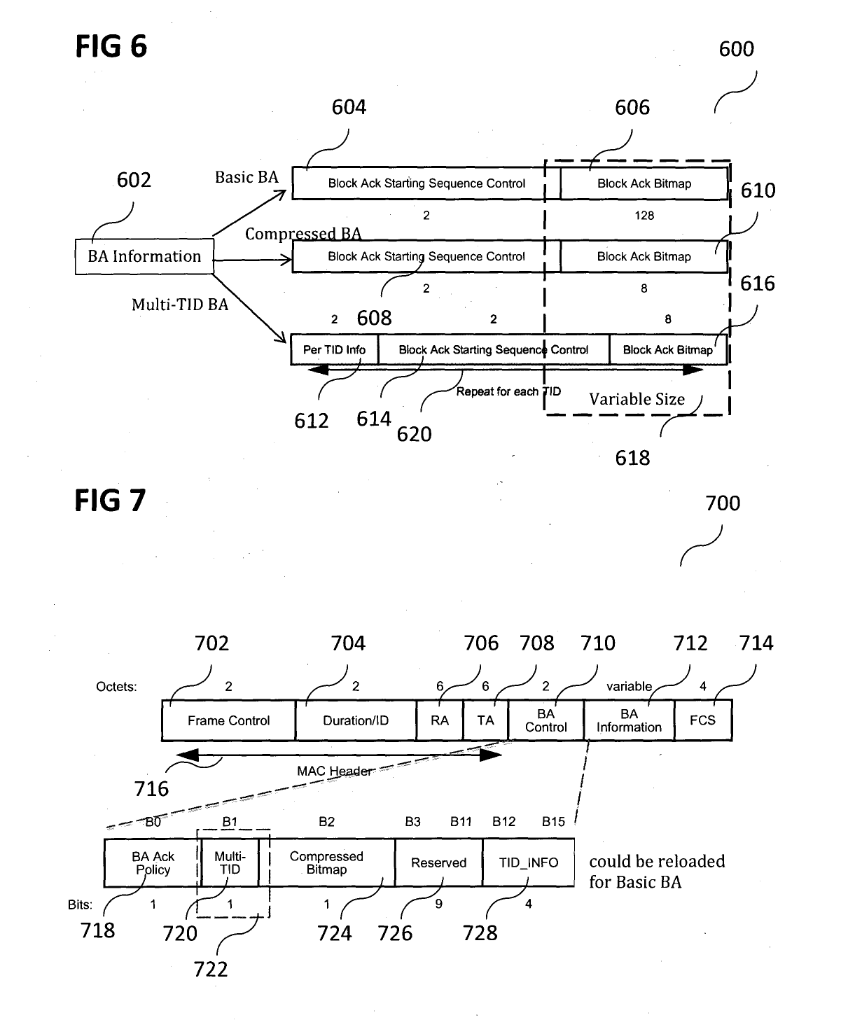

If the STA uses a lower (or more robust) MCS index than what the AP has calculated or assumed, the amount of time remaining after a BA request (or after the last MPDU in the case of implicit BA) may not be able to contain a full BA frame. According to various embodiments, devices and methods may be provided to dynamically reduce the size of the BA bitmap size in order to fit into the remaining time allocated by the AP. Then, the format of the BA frame may be desired to be changed to allow for a variable sized BA bitmap as shown in FIG. 6.

FIG. 6 shows an illustration 600 of a change in BA frames for Basic and Compressed BA according to various embodiments. BA Information 602 may include a Block ACK starting Sequence Control field 604 and a Block Ack Bitmap 606 for Basis BA (first line of FIG. 6). BA Information 602 may include a Block ACK starting Sequence Control field 608 and a Block Ack Bitmap 610 for Compressed BA (second line of FIG. 6).

BA Information 602 may include a Per TID (wherein TID may stand for traffic identifier) Info field 612, a Block ACK starting Sequence Control field 614 and a Block Ack Bitmap 616 for Multi-TID BA (third line of FIG. 6). Like indicated by arrow 620, the fields may be repeated for each TID. The actual BA bitmap may be included in the fields surrounded by the dashed box.

There may be three types of BA: Basic BA, Compressed BA and Multi-TID BA (wherein TID may stand for traffic identifier). The frame size of the Multi-TID BA may be reduced with a smaller set of TIDs than the set indicated in the BA request (which may be referred to as a coarse-grained approach). However, the first two types of BA may have fixed sized frames (for example 128-byte bitmap and 8-byte bitmap, respectively) and hence need to be amended to include an indication of the size of the dynamically reduced bitmap. In a fine-grained approach for Multi-TID BA, the bitmap size could be dynamically reduced in the same manner as that of the other two types of BA, using the reserved bits to indicate the size of the dynamically reduced bitmap.

FIG. 7 shows a BA frame format 700 according to various embodiments.

The size of each BA bitmap may be indicated in the BA control field as shown in FIG. 7. A frame control field 702, a duration/ID (identifier) field 704, a RA (receiver address) field 706, a TA (transmitter address) field 708, a BA control field 710, a BA information field 712, and a FCS 714 may be provided in the BA frame 700. Fields 702, 706, and 708 may be included in the MAC header 716. In the BA control field 710, there may be a BA Ack policy field 718, a Multi-TID field 720, a compressed bitmap field 724, a reserved field 726, and a TID_INFO field 728. There may be 9 reserved bits 726 which may be used to indicate the length of the BA bitmap for Basic and Compressed BA in bytes. Hence out of those 9 bits, 7 bits may be desired to indicate a maximum length of 128 bytes for the Basic BA mode and 3 bits may be desired to indicate a maximum length of 8 bytes for the Compressed BA mode.

It may also be possible to indicate the size of the bitmap in bits rather than in bytes. In that case, 6 bits out of the 9 bits may be desired for the Compressed BA mode. For Basic BA mode, 10 bits would be desired. In that case, both the Compressed Bitmap field is set to 0 and the Multi-TID field is set to 0. However, the latter bit is not crucial to identify the Basic BA mode since it is a reserved mode when the Multi-TID is set to 1 instead. This extra bit as indicated by the dashed box 722 may be combined together with the 9 reserved bits to make up the 10 bits required.

According to various embodiments, the size of the dynamic BA bitmap may be inferred from the number of OFDM (orthogonal frequency-division multiplexing) symbols in the PPDU (physical protocol data unit) since it is the only unknown variable. The relation may be as follows:

n_{OFDM}=┌size_{OH}+size_{BM})*8+nb_{SERVICE}+nb_{TAIL})/nb_{SYM}┐,

where n_{OFDM} may be the number of OFDM symbols in the PPDU after the PHY (physical) layer header (also known as SIG field), sizeOH may be the size of the BA overhead in bytes (for example currently equals 24), size_{BM} may be the size of the dynamic bitmap in bytes (the multiplier 8 may be omitted if the bitmap need not be byte-aligned), nb_{SERVICE} may be the number of bits of the SERVICE field (currently equals 16), nb_{TAIL} may be the number of TAIL bits (currently equals 6 if it is SISO system), and nb_{SYM} may be the number of data bits per symbol as described by the MCS index, for example data rate.

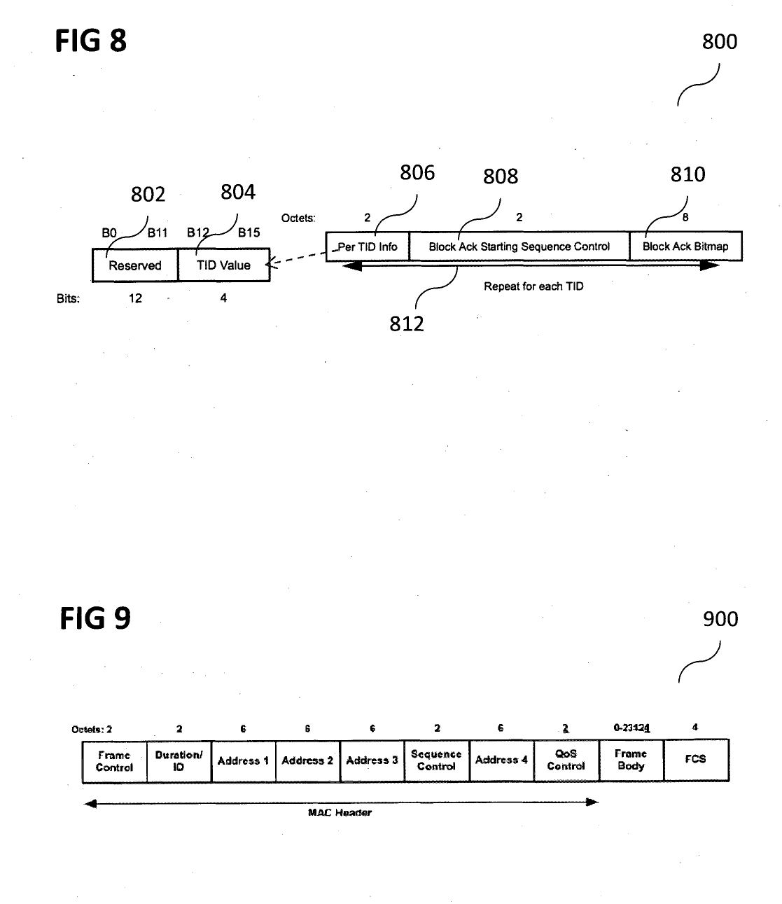

FIG. 8 shows an illustration 800 of per TID INFO in Multi-TID BA according to various embodiments. A Per TID Info field 806, a Block Ack Starting Sequence Control 808, and a Block Ack Bitmap 810 may be provided. A reserved field 802 and a TID value 804 together form the Per TID Info field. Like indicated by arrow 812, fields 806, 808, and 810 may be repeated for each TID in the BA Information field.

For Multi-TID BA, the size of the dynamically reduced bitmap (in bytes) may be indicated using 3 bits out of the 12 reserved bits in the “Per TID INFO” field 806 as shown in FIG. 8. If the length indication is needed in bits, then 6 bits out of the 12 reserved bits are needed.

For the remaining bits in the BA bitmap that cannot fit into the duration specified by the AP, the AP may either:
Allocate a longer duration in the subsequent transmission for BA frame with less data frames in subsequent burst transmission (a sliding-window style of BA would be needed);
Transmit a new BA request to the STA for the remaining frames to be acknowledged; or
Use a mix of both remedies.

It may be possible due to overhead, that after reducing the MCS at the STA, the BA frame may not fit into the remaining duration no matter how much the bitmap size is reduced. However, calculations show that this may only happens for very asymmetric links where the AP uses MCS7 and the STA uses MCS0 or below. The calculations are shown in the following tables.

It is to be noted that the overhead of the BA frame may also be further reduced: the TA (transmitter address) may be substituted with its association ID (AID) and the duration field may be removed, downsizing the BA frame by at least 6 bytes. In the tables below, this is referred to as “Min. Opt”.

TABLE 1
Number of OFDM data symbols for BA using 1 MHz channel

| MCS | bits/sym | Rate | Basic | Comp. | Min. | Min. Opt. |
|---|---|---|---|---|---|---|
| rep2 | 6 | 150 | 207 | 47 | 37 | 29 |
| 0 | 12 | 300 | 104 | 24 | 19 | 15 |
| 1 | 24 | 600 | 52 | 12 | 10 | 8 |
| 2 | 36 | 900 | 35 | 8 | 7 | 5 |
| 3 | 48 | 1200 | 26 | 6 | 5 | 4 |
| 4 | 72 | 1800 | 18 | 4 | 4 | 3 |
| 5 | 96 | 2400 | 13 | 3 | 3 | 2 |
| 6 | 108 | 2700 | 12 | 3 | 3 | 2 |
| 7 | 120 | 3000 | 11 | 3 | 2 | 2 |

TABLE 2
Number of OFDM data symbols for BA using 2 MHz channel

| MCS | bits/sym | Rate | Basic | Comp. | Min. | Min. Opt. |
|---|---|---|---|---|---|---|
| 0 | 24 | 600 | 52 | 12 | 10 | 8 |
| 1 | 48 | 1200 | 26 | 6 | 5 | 4 |
| 2 | 72 | 1800 | 18 | 4 | 4 | 3 |
| 3 | 96 | 2400 | 13 | 3 | 3 | 2 |
| 4 | 144 | 3600 | 9 | 2 | 2 | 2 |
| 5 | 192 | 4800 | 7 | 2 | 2 | 1 |
| 6 | 216 | 5400 | 6 | 2 | 2 | 1 |
| 7 | 240 | 6000 | 6 | 2 | 1 | 1 |

TABLE 3
Number of OFDM data symbols for BA using 4 MHz channel

| MCS | bits/sym | Rate | Basic | Comp. | Min. | Min. Opt. |
|---|---|---|---|---|---|---|
| 0 | 48 | 1200 | 26 | 6 | 5 | 4 |
| 1 | 96 | 2400 | 13 | 3 | 3 | 2 |
| 2 | 144 | 3600 | 9 | 2 | 2 | 2 |
| 3 | 192 | 4800 | 7 | 2 | 2 | 1 |
| 4 | 288 | 7200 | 5 | 1 | 1 | 1 |
| 5 | 384 | 9600 | 4 | 1 | 1 | 1 |
| 6 | 432 | 10800 | 3 | 1 | 1 | 1 |
| 7 | 480 | 12000 | 3 | 1 | 1 | 1 |

According to various embodiments, devices and methods may be provided to set a maximum TXOP (Transmit Opportunity) limit and truncate later, like will be described in the following.

This method desire the AP to set the duration field as the maximum allowable TXOP limit and may give the STA maximum freedom to choose its own MCS for the BA frame. That is, the AP may transmit a modest number of data frames in burst and leaves sufficient channel time for the STA to use a very low rate MCS for the BA frame.

If the remaining duration of the TXOP after receiving the BA frame is non-zero, the AP may prematurely terminate its TXOP by broadcasting a CF-END frame as per the baseline IEEE 802.11-2012 standard.

This method may also be used in conjunction with the method of dynamically reducing the bitmap size described above to avoid complexity of computing the duration field at the AP.

In the following, methods for supporting header compression will be described.

A protocol to support MAC header compression may be provided, alternating between the full MAC headers and compressed headers. The protocol may be used for unidirectional transmission of data frame without acknowledgment and block transfer. According, to the method the dynamic fields may be compressed with a smaller number of bits, improving the efficiency. The PN (Packet Number) incremental value may be fixed to 1 or a fixed positive number so that the compression efficiency for CCMP (Counter Cipher Mode with Block Chaining Message Authentication Code Protocol) header may be achieved higher.

In the following, a MAC header compression protocol will be described.

TABLE 4
Use of the address fields in data frames

| | | | Address | Address | | |
|---|---|---|---|---|---|---|
| | | | 1 (receiv- | 2 (trans- | Address | Address |
| Function | ToDS | FromDS | er) | mitter) | 3 | 4 |
| IBSS | 0 | 0 | DA | SA | BSSID | Not used |
| To AP | 1 | 0 | BSSID | SA | DA | Not used |
| (infra.) | | | | | | |
| From AP | 0 | 1 | DA | BSSID | SA | Not used |
| (infra.) | | | | | | |
| WDS | 1 | 1 | RA | TA | DA | SA |
| (bridge) | | | | | | |

Three types of MAC headers may be described:

A) Full MAC Header (FH), which may be a conventional 802.11 MAC header as shown in illustration 900 of FIG. 9. As we consider MAC header for IEEE 802.11 ah, full MAC header (including CCMP header if applicable) is referred to the MAC header format without compression adopted by IEEE 802.11 ah.

B) Compressed Header (CH), which may remove Constant field from full MAC header (including CCMP header) without causing any ambiguity in the decompression. For example, let us consider the Table 4 for use of the address fields in data frames. When the station (STA) sends data frames to the access point (AP), three addresses are used i.e. A1, A2 and A3. However, when A2=A3, A3 is redundant. In this case, CH can be applied to data frames. When the AP sends data frames to the STA, three addresses are used i.e. A1, A2 and A3. However, when A2=A3, A3 is redundant. Furthermore, when the STA is allocated with AID (association ID), we can replace A1 with AID. In this case, CH can be applied to data frames too.

C) More-Compressed Header (MCH), which is referred to the header with higher compression ratio than CH, reducing the size of dynamic fields such as sequence number. For example, Sequence Number field can be compressed into fewer bits, e.g. 4 bits. PN0-5 fields in CCMP header can be also reduced into fewer bits, e.g. 6 bits.

Two types of data frame transmissions may be differentiated, either with acknowledgment or without acknowledgment. In IEEE 802.11, the use of No Ack is determined by the policy at the QoS STA. When No Ack policy is used, there is no MAC-level recovery, and the reliability of this traffic is reduced. A protective mechanism (such as transmitting using RTS/CTS) may be desired to be used to reduce the probability of other STAs transmitting during the TXOP (Transmission Opportunity).

In the following, src (source; or sender) and dst (destination; or receiver) may be referred to the communicating peers performing the compression and decompression respectively.

When the decompression context is out of synchronization with compression side, either compression or decompression can start the recovery of the context. In the former case, compression side has the responsibility to send out the recovery packets. In the latter case, the decompression side initiates the recovery request and compression side will respond accordingly by sending out the recovery packets.

The compression side may desire to negotiate with the decompression side on the context of compression, e.g. either through some management frame exchange or some MAC header fields. After that, the compression side may start to transmit the data frames with compressed MAC headers, which can be FH, CH or MCH. In some situation, the compression side only transmits CH or MCH. Upon requested by the decompression side explicitly for FH or CH to recover the decompression context, the compression side responds with FH/CH accordingly. Otherwise, MCH may be highly recommended to improve compression ratio. Sometimes, e.g. when unidirectional transmissions occur, the compression side may initiate the recovery without the request from the decompression side.

To decompress the dynamic field in MCH, the decompression side must retain the initial value that is either received earlier though management exchange, FH or CH, or can be inferred from the current context. Once the decompression side receives MCH, it restores the dynamic field by its initial value and compressed bits in MCH to calculate the decompressed value. For example, it can add up two values (initial value and compressed value) to obtain the decompression result for that dynamic field. Over the time, initial value for the dynamic field may be updated through explicit management exchange, FH or CH, or can be inferred from the current context. For example, if the sequence number is considered as dynamic field, once the decompression side detects for the field of sequence number that one MCH with smaller compressed value follows another MCH with larger compressed value, it knows the wrap-around of compressed value of sequence number occurs. Suppose that the range of the sequence number before wrap-around is [ISN_{—min}, ISN_{—max}]. The decompression side may be desired to update the initial value with a proper value, which is (1+ISN_{—max}).

In the following, MAC header compression for two-way communication without management frame exchange for compression will be described.

If the constant fields and/or dynamic fields are not identified during management frame exchange before compressed header is transmitted, the header compression protocol for two-way communication with Ack may be as follows:

a. Source (src) sends out data frame with FH.

b. Destination (dst) acknowledges after data frame with FH has been received successfully and is able to build up the context for decompression of compressed header. If more information are required to set up the decompression context, dst signals (via Ack) to src to send out a few more FHs.

c. src sends out data frame with MCH.

d. dst acknowledges after it receives data frame and successfully decompress the MCH.

e. If the data frame with MCH is not acknowledged due to failure of receiving Ack at src, packet loss at dst or the corrupted packet that cannot be decompressed or decoded by dst, and the value for any dynamic field may encounter the problem of different context in compression and decompression due to e.g. wrap-around of compressed dynamic field, src will send out data frame with CH (or FH if necessary) to recover the context in dst for the decompression. Otherwise, src will send data frame with MCH. Alternatively, dst can request to synchronize the decompression context, simply transmitting a request to src for this purpose.

f. dst recovers the context for decompression after receiving data frame with CH (or FH) and acknowledges for the successful reception.

g. Upon confirmed by Ack from dst, src can send out data frame with MCH again.

h. dst receives data frame with MCH and acknowledges src after successful decompression.

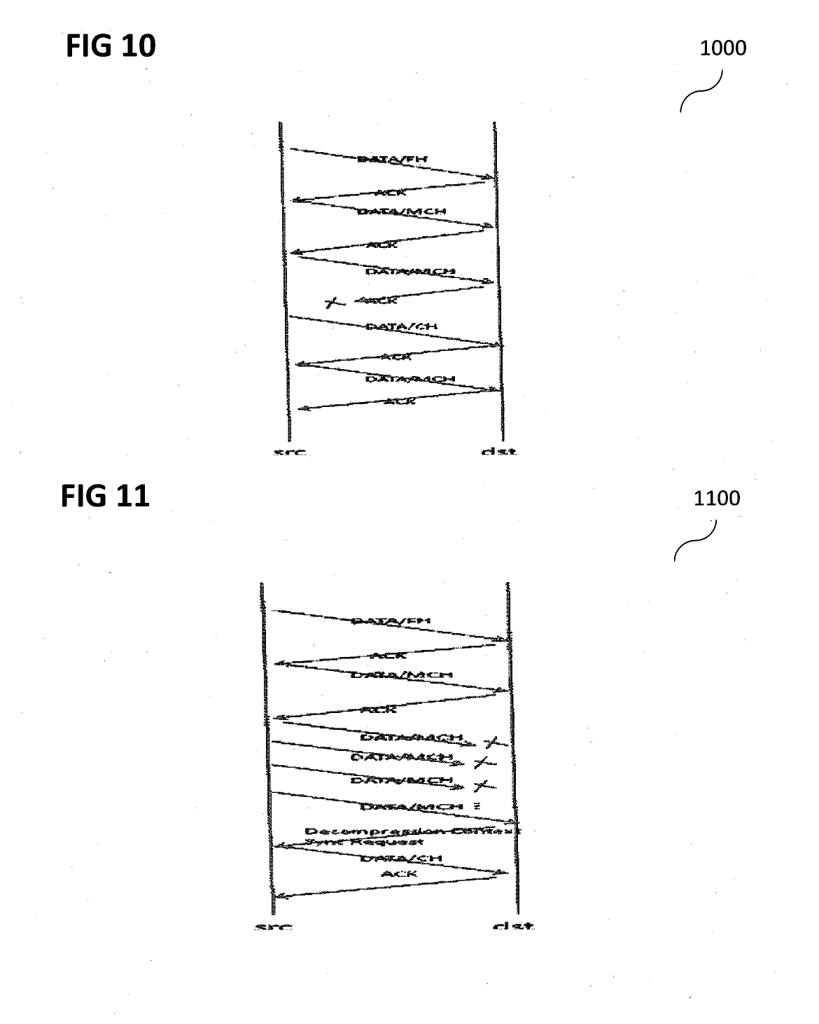

FIG. 10 shows one example 1000 for MAC header compression for two-way communication without management frame exchange for compression where destination doesn't send decompression context synchronization request. FIG. 11 shows one example 1100 for MAC header compression for two-way communication without management frame exchange for compression where destination sends decompression context synchronization request. In FIG. 11, different from FIG. 10, destination detects that it can't receive, decompress or decode the packet properly and initiates the request for context synchronization. If sequence number field is compressed, the source sends out the value of sequence number either without compression or with less compressed bits to help recover the context at the destination.

In the following, MAC header compression for two-way communication with management frame exchange for compression will be described.

If the constant fields and/or dynamic fields are identified during management frame exchange before compressed header is transmitted, FH is not required to be sent for compression/decompression context setup in this protocol. Therefore, the protocol may be revised as follows:

a. Source (src) sends management frame to request for compressed header transmissions for the following data frames and Destination (dst) acknowledges to confirm the compression. i) The compression options may be identified in this management frame exchange, where constant fields are included and dynamic fields may be included and its number of bits required for dynamic fields may be also specified. ii) It is to be noted that there may be a few compression options for each dynamic field. If MAC header for data frame contains the indication for such compression options, dst may be able to identify and decompress accordingly.

b. src sends out data frame with CH (or MCH) for first data frame after management frame exchange to determine the compression options.

c. dst acknowledges after it receives data frame and successfully decompresses the header CH (or MCH). If the data frame with MCH is not acknowledged due to failure of receiving Ack at src, packet loss at dst or the corrupted packet that cannot be decompressed or decoded by dst, and the value for any dynamic field encounters the wrap-around problem, src will send out data frame with CH (or FH if necessary) to recover the context in dst for the decompression. Otherwise, src will send data frame with MCH. Alternatively, dst can request to synchronize the decompression context, simply transmitting a request to src for this purpose.

d. dst recovers the context for decompression after receiving data frame with CH (or FH) and acknowledges for the successful reception.

e. Upon confirmed by Ack from dst, src can send out data frame with MCH again.

f. dst receives data frame with MCH and acknowledges src after successful decompression.

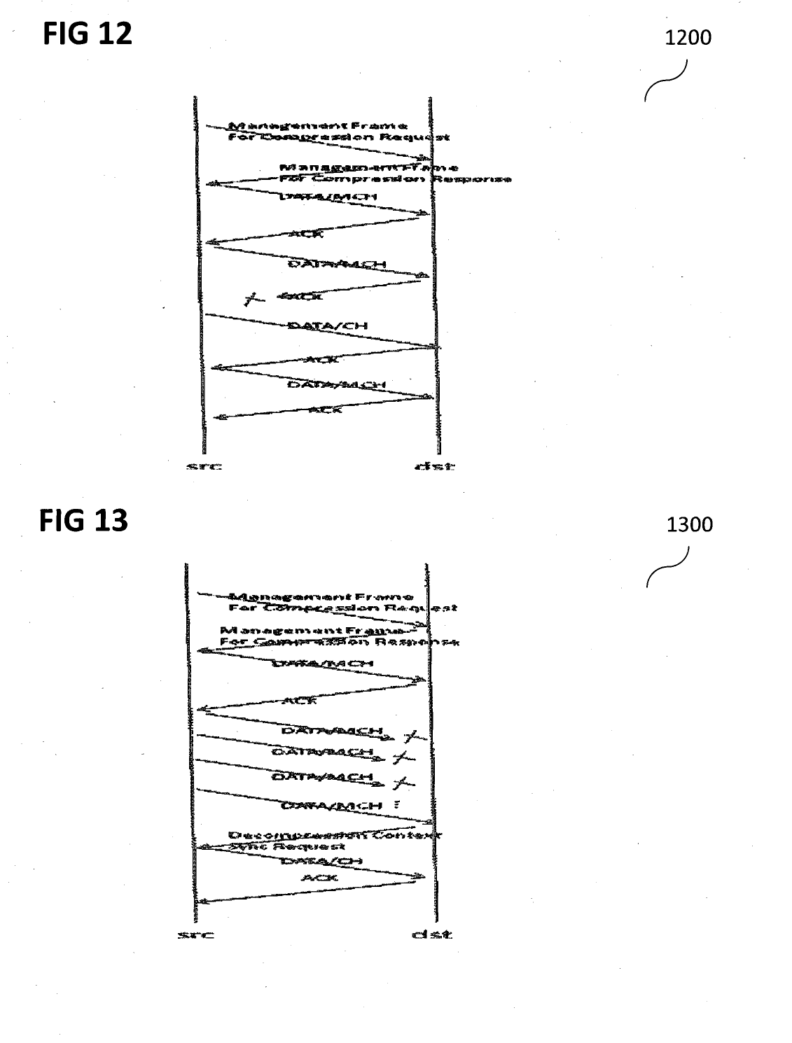

FIG. 12 shows one example 1200 for MAC header compression for two-way communication with management frame exchange for compression where destination doesn't send decompression context synchronization request.

FIG. 13 shows one example 1300 for MAC header compression for two-way communication with management frame exchange for compression where destination sends decompression context synchronization request.

In the following, MAC header compression for unidirectional transmission without management frame exchange for compression will be described.

When there is no management frame exchange to identify constant fields and dynamic fields for compression, the header compression protocol for unidirectional communication without Ack may be as follows:

a. Source (src) sends out data frame with FH.

b. Destination (dst) is able to build up the context for decompression of compressed header after data frame with FH has been received successfully. If more information is required to set up the decompression context, dst may signal (via some management frame for request) to src to send out a few more FHs. Alternatively, src can optionally send out a few more FHs to increase reliabilities.

c. src sends out data frame with MCH.

d. dst receives data frame and successfully decompresses the MCH.

e. src continues to send data frames with MCH for a few times (can be fixed or varied).

f. src will send out data frame with CH (or FH if necessary) to synchronize the context in dst for the decompression. Alternatively, dst can request to synchronize the decompression context, simply transmitting a request to src for this purpose.

g. dst recovers the context for decompression after receiving data frame with CH (or FH).

h. The above steps of data frame with CH and with MCH can be alternated. For example one data frame with CH following four data frames with MCHs.

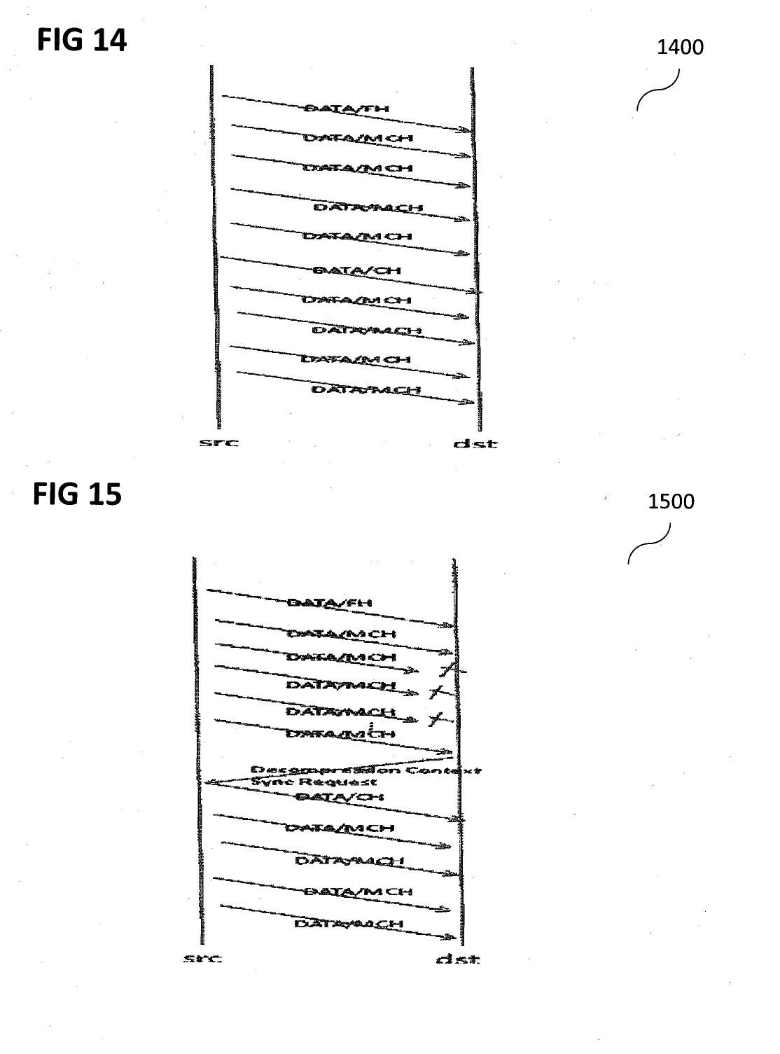

FIG. 14 shows one example 1400 for MAC header compression for unidirectional transmission without management frame exchange for compression where destination doesn't send decompression context synchronization request.

FIG. 15 shows one example 1500 for MAC header compression for unidirectional transmission without management frame exchange for compression where destination sends decompression context synchronization request.

In the following, MAC header compression for unidirectional transmission with management frame exchange for compression will be described.

With management frame exchange for compression to identify the fields to compress and/or how to compress, the header compression protocol for unidirectional communication without Ack may be revised as follows:

a. Source (src) sends management frame to request for compressed header transmissions for the following data frames and Destination (dst) acknowledges to confirm the compression. The compression options can be identified in this management frame exchange, where constant fields are included and dynamic fields may be included and its number of bits required for dynamic fields may also be specified. It is to be noted that there may be a few compression options for each dynamic field. If MAC header for data frame contains the indication for such compression options, dst should be able to identify and decompress accordingly.

b. Destination (dst) is able to build up the context for decompression of compressed header after data frame has been received successfully.

c. src sends out data frame with MCH.

d. dst receives data frame and successfully decompresses MCH.

e. src continues to send data frames with MCH for a few times (can be fixed or varied).

f. src will send out data frame with CH to synchronize the context in dst for the decompression. Alternatively, dst can request to synchronize the decompression context, simply transmitting a request to src for this purpose.

g. dst recovers the context for decompression after receiving data frame with CH.

h. The above steps in which data frames with CH and with MCH are transmitted can be alternated. For example, one or two data frames with CH following four data frames with MCHs.

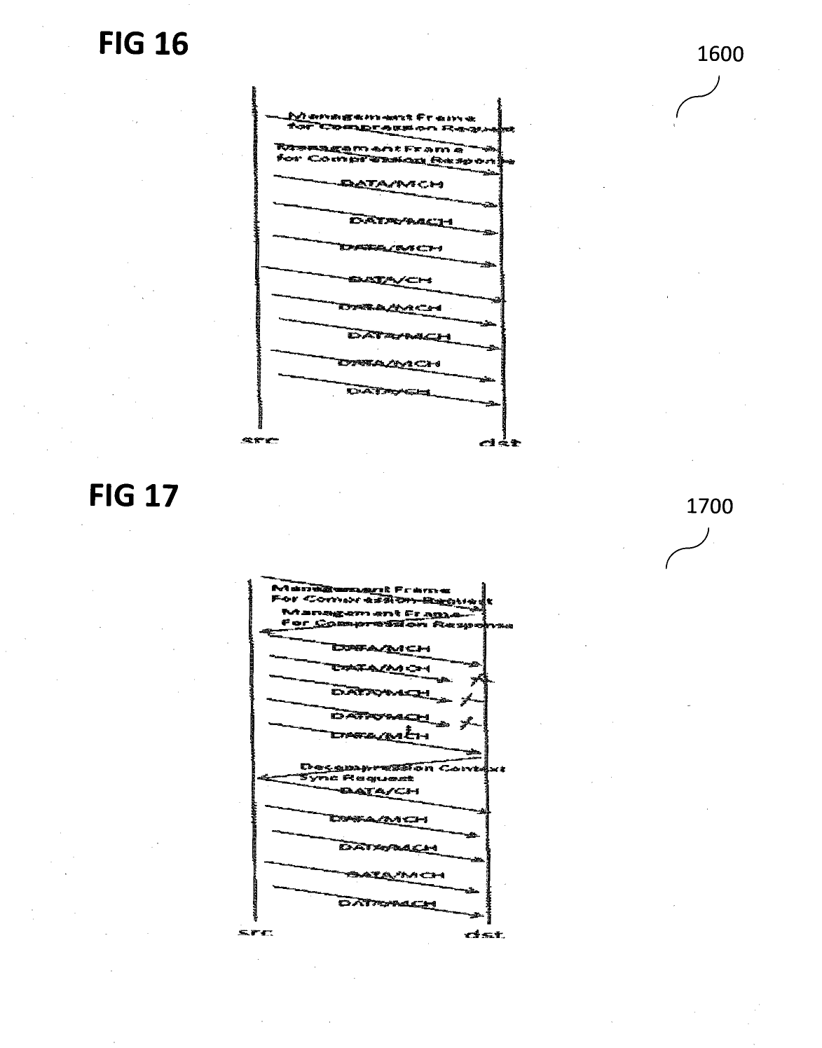

FIG. 16 shows one example 1600 for MAC header compression for unidirectional transmission with management frame exchange for compression where destination doesn't send decompression context synchronization request.

FIG. 17 shows one example 1700 for MAC header compression for unidirectional transmission with management frame exchange for compression where destination sends decompression context synchronization request.

In various embodiments, there may be various compression options i.e. whether the fields in MAC header may be compressed and how to compress may be dependent on the scenarios. Therefore, the method may be designed to support all these options that can be understood by both compression and decompression sides.

In one embodiment, each field may be associated with a bit that is part of one field, which is used to identify whether the field is compressed or not. This method may be feasible for constant field such as the MAC address. For dynamic field such as sequence number, some extra bits may be desired to identify how to compress (i.e. how many bits are used) if there are multiple options for the compression of the field.

In another embodiment, each option may be associated with a number. Thus, when the number of compression options is between 2^{(N-1)} and 2^{N}, totally N bits may be desired to represent all the options. When dst can receive the option number to differentiate the options, it may proceed the decompression without ambiguity.

If the compression options are negotiated through management frame exchange, some information elements (IEs) may be used. Each field may consist of or may include field index (referring to table entries that define all the fields that are possible to compress), compression length in terms of bits (e.g. 0 means the field can be removed in the compressed header). Once dst recognizes the options, the decompression can be proceed without loss of the context.

The number of bits for dynamic field may be dependent on the data rate, the packet loss rate and how frequently less compressed header is transmitted.

When channel is good, data rate is low and packet loss is very rare, or when FH/CH can be transmitted more frequently, a small number of bits (e.g. 4) for sequence number may be sufficient.

When there is no fragmentation is required, the fragment number field may also be removed.

The above example may be applied to CCMP header as well, where the compressed header may use a small number of bits instead of 48 bits for PN0-5 fields in CCMP header.

Since the PN is incremented by a positive number for each MPDU, PN may never repeat for a series of encrypted MPDUs using the same temporal key. For this reason, to improve the compression ratio, we can restrict the increment of the PN to one or a constant positive number or a random number in the range that is predictable or understood by the decompression for each MPDU using the same temporal key. This can be done through some management frames, e.g. management frame exchange before compression starts or authentication/association management frames. For block transfer, if PN increment is set as 1 or a constant positive number, the PN number can be further reduced.

Once temporal key is changed, being compressed dynamic fields, PN0-5 fields need to synchronize between two nodes (src and dst). The synchronization may be through a request by destination (i.e. receiver of the data frames) or the frames with FH or CH by source (i.e. transmitter of the data frames) MAC header compression for Block Transfer.

In the following, CCMP field compression will be described.

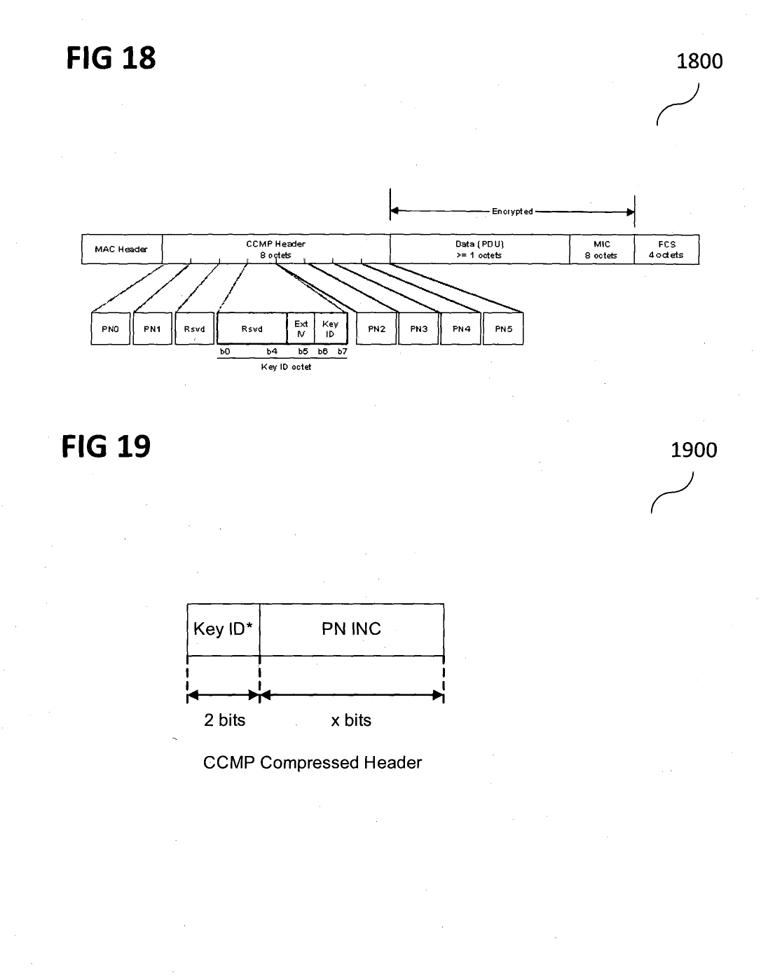

FIG. 18 shows the expanded CCMP MPDU 1800. As described in the 802.11-2012 standards, the packet number (PN) field may be implemented as a 48-bit monotonically incrementing non-negative integer, initialized to 1 when the corresponding temporal key is initialized or refreshed. The CCMP field may be compressed in the following manner:

a. During the synchronization/header compression request, the original PN value may be sent in the request message from the sender to receiver in order for the receiver to record down this value. Similarly, the ExtIV bit may be set to 1 in this request message to inform the receiver that CCMP is used. The Key ID subfield (b6 and b7) of the Key ID octet may also be sent across. Depending on the implementation, if the Key ID subfield does not require changing, then this Key ID subfield may be stored.

b. During the compressed CCMP Header mode, the sender may send the modified CCMP header as shown in FIG. 19 in the MDPU to the receiver instead of the original CCMP header of 802.11 standards. In the CCMP Compressed Header, the Key ID field is still present. However, in implementations where the Key ID field does not require changes, then the Key ID field can be omitted as well. The x-bit PN Incremental value (PN INC field) is sent instead of the incremented 48-bit fresh PN in the original 802.11 standard. The PN INC field contains x-bits, where 1≦x≦48, depending on the size of incremental value for the PN field. For most optimal compression, PN INC field is set to just 1 bit (i.e. the PN field is incremented by 1 for every packet), the worst-case compression would be a 48-bit PN INC field. For example, practically, x can be set as 6.

c. The Reserved bits are omitted and the Ext IV bit (which is always set to 1, and sent during the synchronization/header compression request message) is also omitted. As a result, the original CCMP header of 8 octets (64 bits) can be compressed to an optimal x+2 bits (or x-bits if Key ID field is not required), where 1≦x≦48. Hence, the optimal compressed CCMP header field is 1-bit (without Key ID field) and the worse-case CCMP header field is 50 bits (with 48 bits PN incremental number and 2 bits Key ID).

d. Reconstruction of CCMP Header field at the receiver side may be as follows: Upon receiving the CCMP Compressed Header field, the PN incremental value (PN INC field) may be added to the stored 48-bit PN value to obtain the fresh PN. The fresh PN, together with the stored Ext IV bit and Rsvd bits may be used to expand the CCMP compressed header to the original CCMP header. It should be noted that if the Key ID bits were stored and not transmitted in the compressed CCMP header, then the stored Key ID bits may also be added to the compressed CCMP header to form the original CCMP header. The new fresh PN may be stored (in other words: saved) by the receiver.

FIG. 19 shows an illustration 1900 of the fields of Compressed CCMP header. It is to be noted that the Key ID* field may be removed if the implementation does not require changes to Key ID.

A synchronization/header compression request may be necessary to re-synchronize the sender and receiver should the PN number be exhausted or should the temporal key be refreshed or re-initialized.

If the TKIP (Temporal Key Integrity Protocol) protocol is used, a similar approach may be used to compress the TKIP header.

In the following, block transfer will be described.

MAC header compression for block transfer/ACK may work similar to the schemes described above. When block transfer is initiated by src STA for unidirectional transmission of data frame without Ack, data frame with CH is alternated with every some data frames with MCH.

If there is no management frame exchange for compression request, FH may be sent out firstly.

If there is a management frame exchange for compression request, CH rather than FH may be desired for first transmission when MAC header compression starts.

When block transfer is initiated by src STA for two way communications with Block Ack then the following may apply. If there is no management frame exchange for compression request, FH may be desired be sent out firstly. If there is a management frame exchange for compression request, CH rather than FH may be desired for first transmission when MAC header compression starts. Data frame with CH may be desired and may be sent out when src STA receives the Block Ack that indicates dst STA cannot recover the context for some fields (e.g. dynamic fields).

It will be understood that one of the applications of unidirectional transmission may be VoIP. In this case, if no Ack is chosen for both compression and decompression sides, the MAC header compression method described above can be applied.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for determining information about a communication parameter, the method comprising:
providing information about the communication parameter in at least one of an add block acknowledgement request signal, an acknowledgement signal for an add block acknowledgement request signal, an add block acknowledgement response signal, or an acknowledgement signal for an add block acknowledgement response signal.

2. The method of claim 1,
wherein the communication parameter comprises at least one parameter selected from a list of parameters consisting of:
a modulation and coding scheme;
a data rate;
an uplink modulation and coding scheme;
an uplink data rate;
a downlink modulation and coding scheme;
a downlink data rate;
an index of a modulation and coding scheme;
an index of an uplink modulation and coding scheme;
an index of a downlink modulation and coding scheme;
an index of a data rate;
an index of an uplink data rate;
an index of a downlink data rate;
a difference between an uplink data rate and a downlink data rate;
a difference in indices between a downlink modulation and coding scheme and an uplink modulation and coding scheme; and
a difference in the indices between a downlink data rate and an uplink data rate.

3. The method of claim 1, further comprising:
providing the information about the communication parameter in an indicator in the add block acknowledgement response frame.

4. The method of claim 1, further comprising:
providing the information about the communication parameter in a status code in the add block acknowledgement response frame.

5. The method of claim 1, further comprising:
providing the information about the communication parameter using a dialog token field.

6. The method of claim 1,
wherein the information about the communication parameter comprises at least one of:
an absolute value of at least one communication parameter; or
a change of at least one communication parameter compared to a presently used communication parameter.

7. The method of claim 1, further comprising:
determining a duration for virtual carrier sensing mechanism based on the information about the communication parameter.

8. The method of claim 7, further comprising:
reserving channel time for a block acknowledgement frame based on the determined duration.

9. The method of claim 1, further comprising:
sending or receiving a block acknowledgement signal with dynamic block acknowledgement bitmap size.

10. The method of claim 1, further comprising:
sending or receiving a signal indicating that sending of a block acknowledgement signal is finished.

11. A communication device comprising:
a communication circuit configured to at least one of send or receive information about the communication parameter in at least one of an add block acknowledgement request signal, an acknowledgement signal for an add block acknowledgement request signal, an add block acknowledgement response signal, or an acknowledgement signal for an add block acknowledgement response signal.

12. The communication device of claim 11,
wherein the communication parameter comprises at least one parameter selected from a list of parameters consisting of:
a modulation and coding scheme;
a data rate;
an uplink modulation and coding scheme;
an uplink data rate;
a downlink modulation and coding scheme;
a downlink data rate;
an index of a modulation and coding scheme;
an index of an uplink modulation and coding scheme;
an index of a downlink modulation and coding scheme;
an index of a data rate;
an index of an uplink data rate;
an index of a downlink data rate;
a difference between an uplink data rate and a downlink data rate;
a difference in indices between a downlink modulation and coding scheme and an uplink modulation and coding scheme; and
a difference in indices between a downlink data rate and an uplink data rate.

13. The communication device of claim 11,
wherein the communication circuit is further configured to at least one of send or receive the information about the communication parameter in an indicator in the add block acknowledgement response frame.

14. The communication device of claim 11,
wherein the communication circuit is further configured to at least one of send or receive the information about the communication parameter in a status code in the add block acknowledgement response frame.

15. The communication device of claim 1,
wherein the communication circuit is further configured to at least one of send or receive the information about the communication parameter using a dialog token field.

16. The communication device of claim 1,
wherein the information about the communication parameter comprises at least one of:
an absolute value of at least one communication parameter; or
a change of at least one communication parameter compared to a presently used communication parameter.

17. The communication device of claim 11,
wherein the communication circuit is further configured to determine a duration for virtual carrier sensing mechanism based on the information about the communication parameter.

18. The communication device of claim 17,
wherein the communication circuit is further configured to reserve channel time for a block acknowledgement frame based on the determined duration.

19. The communication device of claim 11,
wherein the communication circuit is further configured to send or receive a block acknowledgement signal with dynamic block acknowledgement bitmap size.

20. The communication device of claim 11,
wherein the communication circuit is further configured to send or receive a signal indicating that sending of a block acknowledgement signal is finished.
